(19) United States
(12) Patent Application Publication
(10) Pub. No.: US 2019/0286173 A1
(43) Pub. Date: Sep. 19, 2019

(54) SYSTEMS AND METHODS FOR DETECTING AIRFLOW IN HEATING, VENTILATION, AND AIR CONDITIONING UNITS

(71) Applicant: Johnson Controls Technology Company, Auburn Hills, MI (US)

(72) Inventor: Stephen B. Pickle, Norman, OK (US)

(21) Appl. No.: 15/939,042

(22) Filed: Mar. 28, 2018

Related U.S. Application Data
(60) Provisional application No. 62/642,482, filed on Mar. 13, 2018.

(51) Int. Cl. G05D 7/06; G05D 23/19; G01F 1/684; F24F 3/048; F24F 1/50; F24F 11/74; F24F 11/88

(52) U.S. Cl. CPC G05D 7/0682; G05D 23/1902; G01F 1/6842; F24F 11/88; F24F 3/048; F24F 1/50; F24F 11/745; G05D 23/1927

(57) ABSTRACT

The present disclosure relates to a heating, ventilating, and air conditioning (HVAC) unit that includes a housing that defines an airflow path and a sensor disposed within the airflow path configured to collect data indicative of airflow. The HVAC unit also includes a controller configured to receive data from the sensor, determine an amount of airflow based on the data, and display the amount of airflow via a display.

### CROSS REFERENCE TO RELATED APPLICATIONS

This application claims priority from and the benefit of U.S. Provisional Application Ser. No. 62/642,482, entitled “SYSTEMS AND METHODS FOR DETECTING AIRFLOW IN HEATING, VENTILATION, AND AIR CONDITIONING UNITS” filed Mar. 13, 2018, which is hereby incorporated by reference.

### BACKGROUND

The present disclosure relates generally to heating, ventilation, and air conditioning (HVAC) systems, and more particularly to detecting flow rates of air provided by HVAC systems.

A wide range of applications exist for HVAC systems. For example, residential, light commercial, commercial, and industrial HVAC systems are used to control temperatures and air quality in residences and other structures. Certain HVAC units can be dedicated to either heating or cooling, although many HVAC units are capable of performing both functions. In general, HVAC systems operate by implementing a thermal cycle in which a refrigerant undergoes alternating phase changes within a refrigeration circuit to remove heat from or deliver heat to a conditioned interior space of a structure. Similar systems are used for vehicle heating and cooling, and as well as for other types of general refrigeration, such as refrigerators, freezers, and chillers.

An air handler, such as a blower or fan, may be included in an HVAC system and provide air to a conditioned space. However, in some circumstances, the air handler may supply air to the conditioned space at an insufficient rate to allow the conditioned space to reach or maintain desired conditions, such as temperature. It is accordingly recognized that it is desirable to provide systems and methods for the HVAC system to reliably detect airflow rates of air supplied by an HVAC system.

### SUMMARY

The present disclosure relates to a heating, ventilation, and air conditioning (HVAC) unit that includes a housing that defines an airflow path and a sensor disposed within the airflow path configured to collect data indicative of airflow. The HVAC unit also includes a controller configured to receive data from the sensor, determine an amount of airflow based on the data, and display the amount of airflow via a display.

The present disclosure also relates to a blower of a heating, ventilation, and air conditioning (HVAC) unit that has an inlet and an outlet and includes a first sensor configured to collect data indicative of a first pressure of air passing through the blower. The blower also includes a second sensor configured to collect data indicative of a second pressure of air passing through the blower. Additionally, the blower includes a controller configured to determine an amount of airflow through the blower based on the data from the first sensor and the second sensor.

The present disclosure further relates to a heating, ventilation, and air conditioning (HVAC) unit that includes a blower configured to deliver conditioned air to a conditioned space along an airflow path and a sensor configured to collect data indicative of a pressure of air passing along the airflow path to the conditioned space. The HVAC unit also includes a controller that has a display. The controller is configured to receive the data from the sensor, determine an amount of airflow along the airflow path based on the data, and display the amount of airflow via the display.

### BRIEF DESCRIPTION OF THE DRAWINGS

FIG. 1 is a perspective view a commercial heating, ventilating, and air conditioning (HVAC) system for building environmental management, in accordance with embodiments described herein;

FIG. 2 is a perspective view of a packaged HVAC unit of the HVAC system illustrated in FIG. 1, in accordance with embodiments described herein;

FIG. 3 is a perspective view of a residential HVAC system, in accordance with embodiments described herein;

FIG. 4 is a schematic diagram of a vapor compression system that may be used in the commercial HVAC system of FIG. 1 and the residential HVAC system of FIG. 3, in accordance with embodiments described herein;

FIG. 5 is a schematic diagram of an airflow detection system, in accordance with embodiments described herein; and

FIG. 6 is a flow diagram of a process for controlling operation of the airflow detection system of FIG. 5, in accordance with embodiments described herein.

### DETAILED DESCRIPTION

The present disclosure is generally directed to an airflow detection system that may be included in an HVAC system and is configured to detect an amount of airflow, such as a value in units of cubic feet per minute and/or a value in units of feet per minute. As set forth below, the disclosed system includes a number of sensors that monitor pressures of air within the HVAC system. As discussed, a controller of the HVAC system may determine an amount of airflow of air supplied by an HVAC unit of the HVAC system based on one or more pressure values detected by sensors of the HVAC system. The controller may determine the amount of airflow at start-up of an HVAC system or HVAC unit. Additionally, the determined amount of airflow may be displayed on a display of a controller of the HVAC system or the HVAC unit. As such, the HVAC system or HVAC unit may determine an amount of airflow during installation or start-up of the HVAC system or HVAC unit, display the amount of airflow, and allow technicians to make air flow adjustments without having to use special instruments.

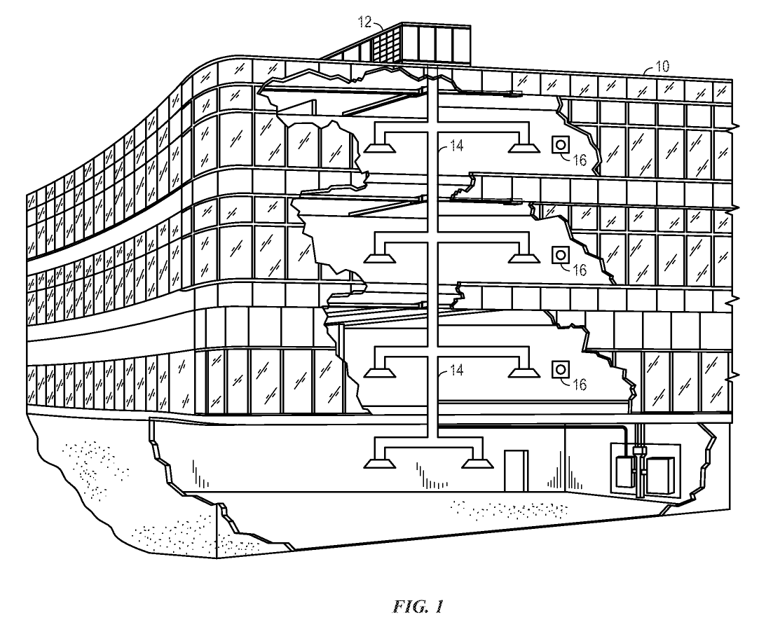

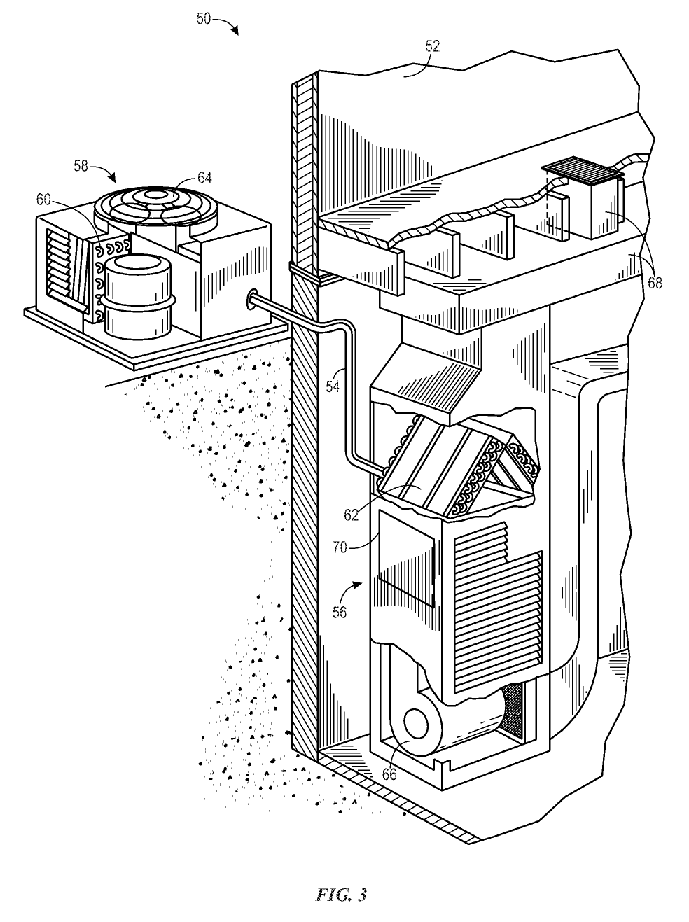

Turning now to the drawings, FIG. 1 illustrates a heating, ventilation, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. However, the HVAC unit 12 may not be an air cooled device. For example, the HVAC unit 12 may be an evaporative cooled device. The HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

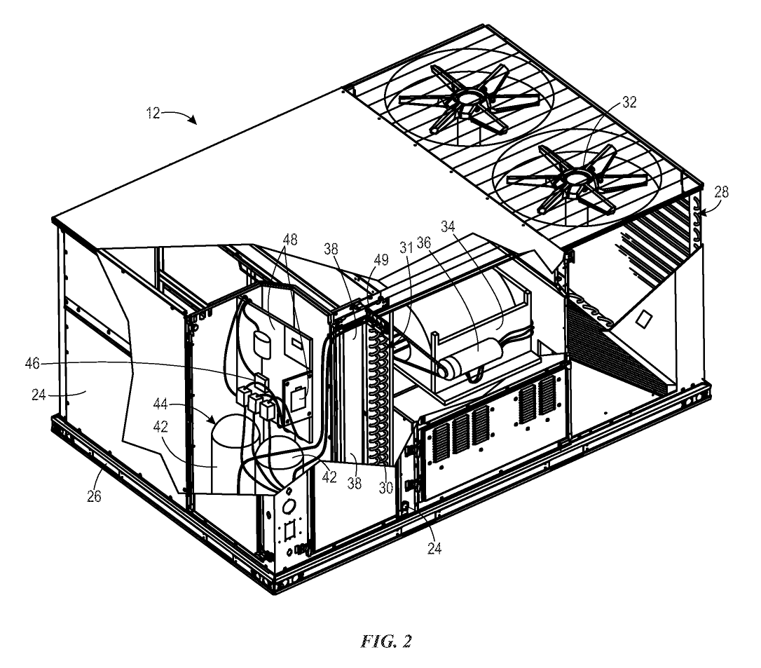

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant (for example, R-410A, steam, or water) through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms (one or more being referred to herein separately or collectively as the control device 16). The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant (which may be expanded by an expansion device, not shown) and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat (plus a small amount), the residential heating and cooling system 50 may become operative to refrigerate additional air for circulation through the residence 52. When the temperature reaches the set point (minus a small amount), the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger (that is, separate from heat exchanger 62), such that air directed by the blower 66 passes over the tubes or pipes and extracts heat from the combustion products. The heated air may then be routed from the furnace system 70 to the ductwork 68 for heating the residence 52.

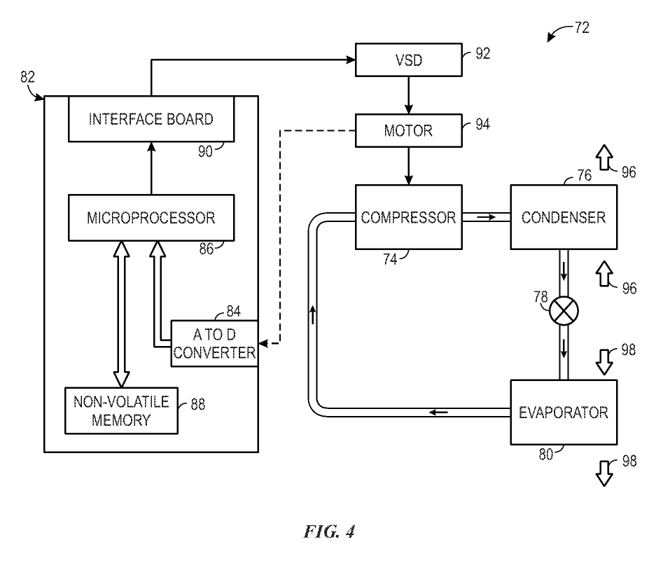

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. Each of the illustrated components, such as the microprocessor or processor 86, may be representative of multiple such components. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As discussed above, the HVAC system of FIG. 1 and the residential heating and cooling system 50 include air handlers, such as the blower assembly 34 and the blower 66, respectively, that can supply conditioned air to a conditioned space. As discussed below with respect to FIG. 5, sensors, such as pressure sensors, may be included in HVAC systems. A controller, such as the control panel 82 or the control board 48, may receive data from the sensors and determine an amount of airflow provided by an air handler of the HVAC system based on the sensor data. Additionally, the amount of airflow may be displayed on a display included in the HVAC system, such as display included in the controller. While the discussion herein refers to the HVAC unit 12, it should be noted that different types of HVAC units or systems may be used instead. That is, the discussion above it not limited to packaged HVAC units and/or commercial or industrial HVAC systems, such as those illustrated in FIGS. 1 and 2. For example, the techniques discussed herein may be implemented in the residential heating and cooling system 50 of FIG. 3.

With the foregoing discussion in mind, FIG. 5 is a schematic diagram of an embodiment of an airflow detection system 100 that may be included in an HVAC unit, such as the HVAC unit 12 of FIG. 1. As illustrated, the airflow detection system 100 includes sensors 102 that are communicatively coupled to the control board 48. The sensors 102 may collect data regarding the blower assembly 34 of the HVAC unit 12. For example, the sensors 102 may be pressure sensors that detect pressures of air that enters and exits the blower assembly 34. More specifically, the sensor 102A may detect a pressure of air at an inlet 104 or inlet section of the blower assembly 34, and the sensor 102B may detect a pressure of air supplied by the blower assembly 34 at an outlet 106 or outlet section of the blower assembly 34. However, in other embodiments, the placement of the sensors 102 may differ. For instance, the sensors 102A and 102B may not be disposed at the inlet 104 and outlet 106 of the blower assembly 34. For example, the sensor 102A may be positioned in another suitable location upstream of the blower assembly 34, and the sensor 102B may be positioned in a different, suitable location of the blower assembly 34, such as within a fan compartment of the blower assembly 34 or a location downstream of the blower assembly 34. Moreover, while the illustrated embodiment includes two sensors 102, it should be noted that the airflow detection system 100 may include one sensor 102, such as the sensor 102B, in other embodiments. Additionally, the airflow detection system 100 may include more than two sensors 102 in other embodiments.

The control board 48 may also be communicatively coupled to the motor 36 that drives the blower assembly 34. As with the motor 94, the motor 36 may be electrically coupled to a VSD. Moreover, the motor 36 may include any type of electric motor that can be powered by a VSD or directly from an AC or DC power source, such as a switched reluctance motor, an induction motor, an electronically commutated permanent magnet motor, or another suitable motor. As discussed below, the control board 48 may adjust an operation of the blower assembly 34 based on the pressure readings from the sensors 102.

Additionally, as illustrated, the control board 48 includes a display 108, through which information associated with the airflow detection system 100 can by displayed. For example, pressure values detected by the sensors 102 may be displayed via the display 108. Additionally, an amount of airflow determined based on one or more pressure values from the sensors 102 may also be displayed via the display 108. For example, the amount of airflow determined may be an estimated amount of airflow.

The memory 88 of the control board 48 includes a profile 112. The profile 112 may include fan data, fan characteristics, test data, fan curves, formulas, and algorithms that the processor 86 may utilize to make various determinations based on data from the sensors 102, such as determining an amount of airflow based on data from the sensors 102. For instance, fan curves, fan data, fan characteristics, and so forth may provide a relationship between amounts of airflow a fan can deliver and pressures associated with those amounts of airflow. Fan curves and the like may also provide a relationship between fan velocity, such as a rotational velocities, amounts of airflow, and pressures associated with various combinations of fan velocities and amounts of airflow. Additionally, the profile 112 may be specific to an HVAC unit of which the airflow detection system 100 is a part and/or to components of the airflow detection system 100. For example, the profile 112 may be specific to a model of the blower assembly 34. In some embodiments, the profile 112 may include information regarding multiple HVAC units or models of components that may be included in the airflow detection system 100. In such embodiments, a user may select a model of the HVAC unit in which the airflow detection system 100 or specific components of the airflow detection system 100, such as the blower assembly 34, and the processor 86 may utilize the fan curves, fan data, fan characteristics, test data, formulas, and algorithms of the profile 112 that correspond to the user's selection.

The control board 48 may determine an amount of airflow utilizing the profile 112 and data collected from the sensors 102. More specifically, in embodiments of the airflow detection system 100 that include a single sensor, such as sensor 102B, the processor 86 of the control board 48 may determine an amount of airflow based on a reading from the sensor 102B, a velocity, such as a rotational velocity, of blower assembly 34, and the profile 112. For instance, the processor 86 may determine a pressure of the air supplied by the blower assembly 34 based on data collected by the sensor 102B. Additionally, the processor 86 may determine the speed of the blower assembly 34, such as a value in rotations per minute (RPM), based on a value stored in the memory 88 or a lookup table stored in the memory 88. For example, the motor 36 may operate at various speeds, each of which corresponds to a speed of the blower assembly 34. The lookup table may describe the relationship between speeds of the motor 36 and the speed of the blower assembly 34. The processor 86 may send commands for the motor 36 to operate at a certain speed and determine the speed of the blower assembly 34 based on the speed of the motor 36 using the lookup table.

Based on the speed of the blower assembly 34 and the pressure determined based on data from the sensor 102B, the processor 86 may determine the amount of airflow, such as a value of cubic feet per minute of air supplied by the blower assembly 34. In particular, the processor 86 may utilize another lookup table, a formula, and/or an algorithm included in the profile 112. For example, a lookup table, formula, and/or algorithm included in the profile 112 may include a value of the amount of airflow based on a value for the speed of the blower assembly 34 and an air pressure as determined based on data collected via the sensor 102B.

Similarly, the control board 48 may also determine an amount of airflow for embodiments of the airflow detection system 100 that include two sensors 102. More specifically, the processor 86 may determine the amount of airflow based on a difference between a pressure measured by the sensor 102A and another pressure measured by the sensor 102B. In other words, the processor 86 may determine the amount of airflow based on a difference of a pressure of air upstream of the blower assembly 34 and a pressure of air downstream of the blower assembly 34. For example, the processor 86 may utilize a fan curve, formula, or algorithm included in the profile 112 that relate the difference in pressure values to an amount of airflow.

Furthermore, the airflow detection system 100 may be used during installation, startup, and everyday use of an HVAC unit or system in which the airflow detection system 100 is included. For example, a technician installing an HVAC unit that includes the airflow detection system 100 may make adjustments to the HVAC unit or an HVAC system in which the HVAC unit is included based on an amount of airflow that is determined by the control board 48 and/or displayed via the display 108. Moreover, in some embodiments, the control board 48 may be communicatively coupled to electronic devices, such as phones, tablets, computers, and other suitable electronic devices, via a wireless network or another manner. The electronic devices may receive the determined value of the amount of airflow and display the amount of airflow on one or more displays of the electronic devices.

Additionally, the control board 48 may alter operation of an HVAC unit or system in which the airflow detection system 100 is included. For example, the control board 48 may adjust the speed of the blower assembly 34 based on a comparison of a determined amount of airflow to a threshold value, which may be stored on the memory 88. When the determined amount of airflow falls below the threshold, the control board 48 may cause the blower assembly 34 to operate at a higher speed. Additionally, when the amount of airflow exceeds another threshold, the control board 48 may cause the blower assembly 34 to operate at a lower speed.

The techniques of the present application may also be used in HVAC systems that employ multiple HVAC units. For example, a building, such as building 10 in FIG. 1, may be supplied with conditioned air from two or more HVAC units that are communicatively coupled to one another. A central controller or each control board 48 of the HVAC units may receive data from sensors 102 of the two or more HVAC units and determine an amount of airflow for each HVAC unit as well as a total amount of airflow for the air supplied to the building by the HVAC units. In other words, a controller that is communicatively coupled to controls board of two more HVAC units, or a control board 48 of an HVAC unit that is communicatively coupled to the control board of one or more HVAC units may receive data from the sensors associated with the blower assemblies in each of the multiple HVAC units and determine amounts of airflow associated with each of the HVAC units and a total amount of airflow for the air supplied by the HVAC units. Similar to the discussion above, thresholds specific to each HVAC unit may be used. For example, when the amount of airflow provided by an HVAC unit exceeds a maximum threshold or is below a minimum threshold, the central controller or control board 48 of the HVAC unit may alter operation of the blower assembly 34 of the HVAC unit as described above. Additionally, thresholds concerning the overall amount of airflow may also be utilized. For instance, thresholds regarding a minimum and maximum amount of airflow for the building may be stored on the memory 88 or in the profile 112. When the sum of the amounts of airflow of the HVAC units is below the minimum amount of airflow, the control board 48 or central controller may cause one of more of the blower assemblies 34 of the HVAC units to operate at a faster speed. Conversely, when the sum of the amounts of airflow of the HVAC units is greater than the maximum amount of airflow, the control board 48 or central controller may cause one of more of the blower assemblies 34 of the HVAC units to operate at a slower speed.

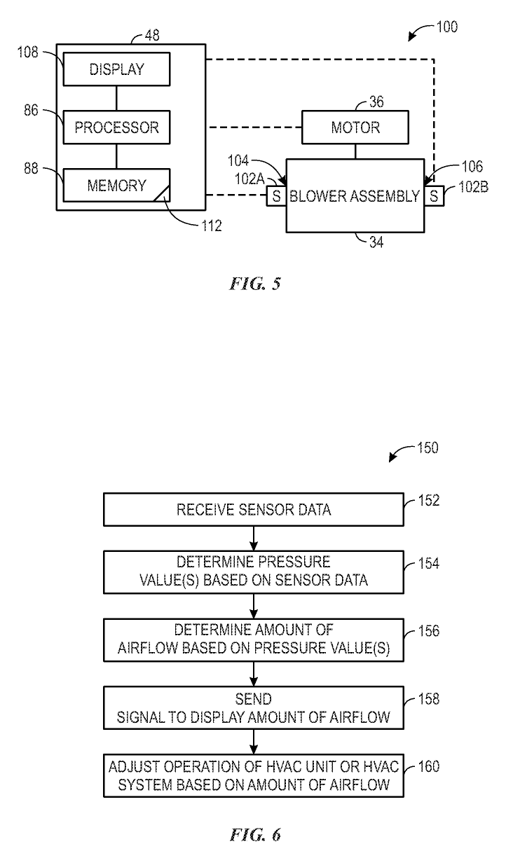

Keeping the discussion of FIG. 5 in mind, FIG. 6 is a flow chart of a process 150 for controlling operation of the airflow detection system 100. The process 150 may be carried out by the processor 86 of the control board 48 or another suitable processor. Moreover, it should be noted that, in some embodiments, some of the steps of the process 150 described below may be omitted.

At block 152, the processor 86 may receive data from one or more sensors 102 of the airflow detection system 100. As discussed above, the sensors 102 may be pressure sensors that detect pressure values of air upstream and downstream of the blower assembly 34. In other words, the data from the sensors 102 may be indicative of one or more air pressures.

At block 154, the processor 86 may determine pressure values based on the data from the sensors 102. For example, in embodiments of the airflow detection system 100 that include one sensor 102, such as sensor 102B, the processor 86 may determine a single air pressure value. However, in embodiments of the airflow detection system 100 that include two sensors 102, the processor 86 may determine pressure values based on the data from each of the sensors 102.

At block 156, the processor 86 may determine an amount of airflow based on the pressure values determined at block 154. For example, as described above, in embodiments of the airflow detection system 100 that include one sensor 102, such as sensor 102B, the processor 86 may determine the amount of airflow based on the pressure associated with the sensors 102B as well as a velocity or rotational speed of the blower assembly 34. Furthermore, as also described above, in embodiments of the airflow detection system 100 that include both sensors 102A and 102B, the processor 86 may determine the amount of airflow based on a difference between the pressure values associated with the sensors 102A and 102B.

At block 158, the processor 86 may send a signal for the display 108 to display the determine amount of airflow. For example, based on the signal send from the processor 86, the display 108 may show the amount of airflow in units of cubic feet per minute. In addition or in the alternative to displaying the amount of airflow via the display 108, in embodiments in which the processor 86 is communicatively coupled to other electronic devices, the amount of airflow may be displayed via displays of the other electronic devices.

At block 160, the processor 86 may adjust an operation of an HVAC unit or HVAC system in which the airflow detection system 100 is included. For example, as discussed above, the processor 86 may alter a speed of the blower assembly 34 based on the determined amount of airflow exceeding or falling under various thresholds discussed above.

While only certain features and embodiments of the present disclosure have been illustrated and described, many modifications and changes may occur to those skilled in the art without materially departing from the novel teachings and advantages of the subject matter recited in the claims. For instance, the modifications and changes may include variations in sizes, dimensions, structures, shapes and proportions of the various elements, values of parameters such as temperatures or pressures, mounting arrangements, use of materials, colors, orientations, and the like. The order or sequence of any process or method steps may be varied or re-sequenced according to alternative embodiments. It is, therefore, to be understood that the appended claims are intended to cover all such modifications and changes as fall within the true spirit of the present disclosure. Furthermore, in an effort to provide a concise description of the exemplary embodiments, all features of an actual implementation may not have been described, such as those unrelated to the presently contemplated best mode of carrying out the present disclosure or those unrelated to enabling the claimed embodiments. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilation, and air conditioning (HVAC) unit, comprising:
a housing that defines an airflow path;
a sensor disposed within the airflow path configured to collect data indicative of airflow; and
a controller configured to receive data from the sensor, determine an amount of airflow based on the data, and provide an indication of the amount of airflow for display via a display.

2. The HVAC unit of claim 1, wherein the controller comprises the display configured to display the amount of airflow.

3. The HVAC unit of claim 1, wherein the HVAC unit includes an air handler and the sensor is disposed at an outlet of the air handler.

4. The HVAC unit of claim 1, wherein the sensor is a first sensor and the data is indicative of a first pressure, and further comprising a second sensor configured to collect data indicative of a second pressure of air.

5. The HVAC unit of claim 4, wherein the HVAC unit is configured to motivate air through the airflow path from an upstream location to a downstream location, and the airflow path has the second sensor positioned downstream of the first sensor along the airflow path.

6. The HVAC unit of claim 4, wherein the HVAC unit has a blower and the first sensor is disposed proximate to an outlet section of the blower of the HVAC unit.

7. The HVAC unit of claim 6, wherein the second sensor is disposed at an inlet section of the blower of the HVAC unit.

8. The HVAC unit of claim 6, wherein the controller is configured to determine the amount of airflow based on a differential between the first pressure and the second pressure.

9. The HVAC unit of claim 8, wherein the controller comprises memory storing a characteristic profile specific to a model of the HVAC unit, wherein the controller is configured to determine the amount of airflow based on the characteristic profile.

10. The HVAC unit of claim 1, wherein the HVAC unit comprises a rooftop unit.

11. The HVAC unit of claim 1, wherein the controller is configured to adjust an operation of the HVAC unit based on the amount of airflow.

12. A blower of a heating, ventilation, and air conditioning (HVAC) unit having an inlet section and an outlet section, comprising:
a first sensor configured to collect data indicative of a first pressure of air passing through the blower inlet section;
a second sensor configured to collect data indicative of a second pressure of air passing through the blower outlet section; and
a controller configured to determine an amount of airflow through the blower based on the data from the first sensor and the second sensor.

13. The blower of claim 12, wherein the controller is configured to determine the amount of airflow based on a differential between the data indicative of the first pressure and the data indicative of the second pressure.

14. The blower of claim 12, wherein the controller comprises memory storing a profile specific to a model of the HVAC unit, wherein the controller is configured to determine the amount of airflow based on the profile.

15. The blower of claim 14, wherein the controller is communicatively coupled to a display and is configured to send a command to the display to display the amount of airflow.

16. The blower of claim 12, wherein the amount of airflow comprises a value in units of cubic feet per minute.

17. The blower of claim 12, wherein the controller is configured to adjust an operation of the blower by adjusting its speed.

18. The blower of claim 12, wherein the controller is configured to:
determine whether the amount of airflow is less than a threshold amount; and
adjust an operation of the blower when the amount of airflow is less than the threshold amount.

19. The blower of claim 12, wherein the HVAC unit is a rooftop unit, and the rooftop unit further comprises a display configured to display the amount of airflow.

20. The blower of claim 12, wherein the first sensor is a first pressure sensor, and the second sensor is a second pressure sensor.

21. A heating, ventilation, and air conditioning (HVAC) unit, comprising:
a blower configured to deliver conditioned air to a conditioned space along an airflow path;
a sensor configured to collect data indicative of a pressure of air passing along the airflow path to the conditioned space; and
a controller comprising a display, wherein the controller is configured to receive data from the sensor, determine an amount of airflow along the airflow path based on the data, and display the amount of airflow via the display.

22. The HVAC unit of claim 21, wherein the sensor is a first sensor and the pressure is a first pressure of air supplied by the blower, and the HVAC unit comprises a second sensor configured to collect data indicative of a second pressure of air passing along the airflow path and motivated by the blower.

23. The HVAC unit of claim 22, wherein the HVAC unit is configured to motivate air through the airflow path from an upstream location to a downstream location, and wherein the first sensor is disposed downstream, and the second sensor is disposed upstream.

24. The HVAC unit of claim 23, wherein the controller is configured to determine the amount of airflow based on a differential between the first pressure and the second pressure.

25. The HVAC unit of claim 21, wherein the controller comprises memory storing a profile specific to a model of the HVAC unit, wherein the controller is configured to determine the amount of airflow based on the profile.

26. The HVAC unit of claim 25, wherein the profile is derived from a fan curve associated with the model of the HVAC unit.
